(19) United States
(12) Patent Application Publication
(10) Pub. No.: US 2016/0370469 A1
(43) Pub. Date: Dec. 22, 2016

(54) ON-BOARD UNIT AND SPOOFING DETECTING METHOD

(71) Applicant: MITSUBISHI HEAVY INDUSTRIES, LTD., Tokyo (JP)

(72) Inventors: Yoshihiro MABUCHI, Tokyo (JP); Masato IEHARA, Tokyo (JP); Kenji FUJITA, Tokyo (JP); Taizo YAMAGUCHI, Tokyo (JP)

(21) Appl. No.: 14/901,722

(22) PCT Filed: Jul. 2, 2014
(86) PCT No.: PCT/JP2014/067634

§ 371 Date: Dec. 29, 2015

(30) Foreign Application Priority Data
Jul. 3, 2013 (JP) 2013-139990

(51) Int. Cl. G01S 19/21

(52) U.S. Cl. CPC G01S 19/215

(57) ABSTRACT

An on-board unit includes a positioning section, a positioning result storage section, and a processing section. The positioning section is configured to output a positioning result showing a current position of a vehicle based on a positioning signal received from an artificial satellite. The positioning result storage section is configured to store the positioning result in relation to a time. The processing section is configured to detect a spoofing based on whether a movement of the vehicle satisfies a given condition, by using a past positioning result stored in the positioning result storage section and a current positioning result measured by the positioning section.

### TECHNICAL FIELD

The present invention relates to an on-board unit that uses GNSS (Global Navigation Satellite System).

### BACKGROUND ART

A satellite positioning system is used that estimates the position of a vehicle and so on on the ground by using signals generated from artificial satellites. As such a technique, GNSS (Global Navigation Satellite Systems) such as GPS (Global Positioning System), GLONASS, and Galileo system are known.

By using the satellite positioning system, for example, charging processing to the vehicle that runs on an area set as a toll highway can be carried out based on the positioning result of the vehicle by the artificial satellites.

### CITATION LIST

[Patent Literature 1]: JP 2008-510138A

[Patent Literature 2]: Singaporean Patent Publication 171571A

### SUMMARY OF THE INVENTION

In the satellite positioning system, a technique called a spoofing is known in which the estimated position is made to be mistaken as a position different from an actual position by camouflaging positioning signals transmitted from the artificial satellites. A technique is demanded that makes it possible to detect the spoofing, in order to carry out the charging process to the vehicle on the toll highway properly. Patent Literatures 1 and 2 are examples of the technique to cope with the spoofing.

In an aspect of the present invention, the on-board unit on-board unit includes: a positioning section configured to output a positioning result showing a current position of a vehicle based on a positioning signal received from an artificial satellite; a positioning result storage section configured to store the positioning result in relation to a time; and a processing section configured to detect a spoofing based on whether a movement of the vehicle satisfies a given condition, by using a past positioning result stored in the positioning result storage section and a current positioning result measured by the positioning section.

In an aspect of the present invention, A spoofing detecting method of an on-board unit, includes: outputting a positioning result showing a current position of a vehicle based on a positioning signal received from an artificial satellite; storing the positioning result in a storage device in relation to a time; and detecting a spoofing based on whether a movement of the vehicle satisfies a given condition, by using a past positioning result stored in the positioning result storage section and a current positioning result measured by the positioning section.

According to the present invention, the technique which makes the spoofing detection possible is provided.

### BRIEF DESCRIPTION OF THE DRAWINGS

FIG. 1 is a diagram showing a configuration of a satellite positioning system.

FIG. 2 is a diagram showing a configuration of an on-board unit.

FIG. 3 is a diagram showing a configuration of a spoofing detecting section.

FIG. 4 is a diagram showing an operation of the on-board unit.

FIG. 5 is a diagram showing an operation of the on-board unit.

FIG. 6 is a diagram showing a configuration of the satellite positioning system.

FIG. 7 is a diagram showing a configuration of the on-board unit.

FIG. 8 is a diagram showing a configuration of a spoofing detecting section.

FIG. 9 is a diagram showing an operation of the on-board unit.

FIG. 10 is a diagram showing an operation of the on-board unit.

FIG. 11 is a diagram showing an operation of the on-board unit.

FIG. 12 is a diagram showing a base station ID table.

### DESCRIPTION OF EMBODIMENTS

### First Embodiment

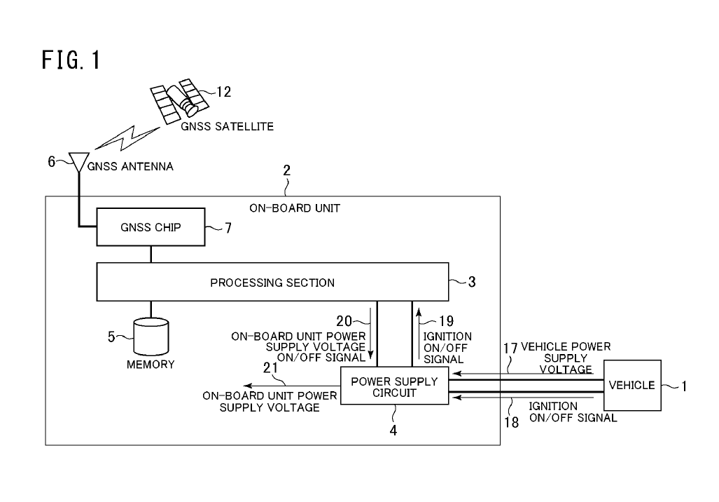

Hereinafter, embodiments of the present invention will be described with reference to the attached drawings. FIG. 1 shows a configuration of a satellite positioning system according to a first embodiment of the present invention. In the satellite positioning system, the position of a vehicle 1 is estimated by using GNSS satellite information carried by positioning signals transmitted from a plurality of GNSS satellites 12 (only one is shown).

An on-board unit 2 is loaded on a vehicle 1 of a user. The on-board unit 2 receives GNSS satellite information by a GNSS antenna 6. A GNSS chip 7 of the on-board unit 2 estimates a three-dimensional current position of the vehicle 1 on the ground based on the received GNSS satellite information to output the estimated current position as a positioning result. The on-board unit 2 has a processing section 3 as a computer that carries out charging processing and so on by using the positioning result outputted from the GNSS chip 7. The processing section 3 stores the positioning result in a positioning result storage area 5 disposed in a storage unit.

The vehicle 1 has a battery, and supplies a vehicle power supply voltage 17 from the battery to the on-board unit 2. The vehicle power supply voltage 17 is supplied to the power supply circuit 4 of the on-board unit 2. The vehicle 1 outputs to the on-board unit 2, an ignition ON/OFF signal 18 showing whether an ignition key is rotated to an ON direction to turn on an engine, or to an OFF direction to turn off the engine. The ignition ON/OFF signal 18 is transmitted to the processing section 3 as an ignition ON/OFF signal 19 via the power supply circuit 4.

The processing section 3 outputs an on-board unit power supply voltage ON/OFF signal 20 to the power supply circuit 4 according to an ignition ON/OFF signal 19 indicating that the ignition of the vehicle 1 has been turned on, to instruct the power supply circuit 4 of the on-board unit 2 to be turned on. The power supply circuit 4 performs a power conversion to the vehicle power supply voltage 17 supplied from the vehicle 1 according to need, in response to the on-board unit power supply voltage ON/OFF signal 20, to output the on-board unit power supply voltage 21. Various circuits of the on-board unit 2 are driven with the on-board unit power supply voltage 21.

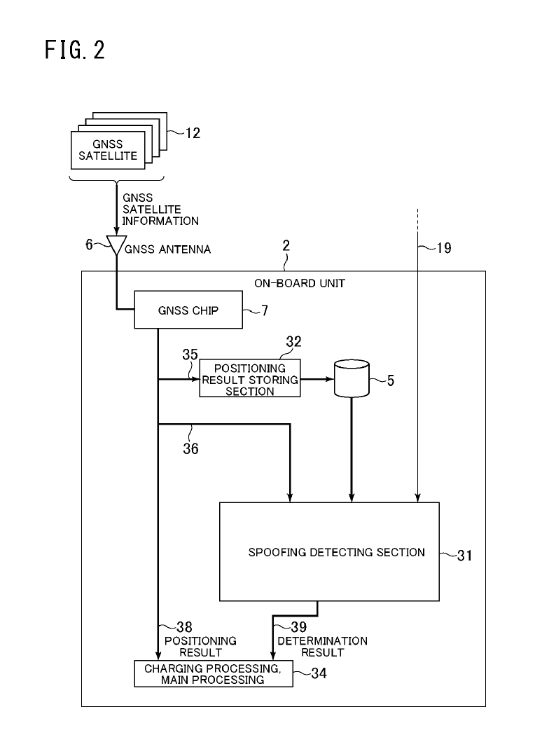

FIG. 2 shows a configuration of the on-board unit 2. The on-board unit 2 has the GNSS antenna 6, the GNSS chip 7, a positioning result storing section 32, a positioning result storage area 5, a main processing section 34 and a spoofing detecting section 31. Of them, the positioning result storing section 32, the main processing section 34 and the spoofing detecting section 31 correspond to the processing section 3 of FIG. 1. Each of these sections which are contained in the processing section 3 may be realized in software by a program executed by a CPU, or in hardware by an individual circuit having a corresponding function. When the GNSS chip 7 outputs a positioning result 35, the positioning result storing section 32 stores the positioning result 35 in the positioning result storage area 5 together with the current time. The positioning result 35 is related to the positioning time and stored in the positioning result storage area 5.

The positioning result 36 outputted from the GNSS chip 7 is further supplied to the spoofing detecting section 31. The spoofing detecting section 31 outputs a determination result 39 showing whether or not a spoofing has been carried out, based on the positioning result 36, the past positioning result 35 stored in the positioning result storage area 5 and the positioning time. The main processing section 34 executes the charging processing and so on when the vehicle 1 runs on a toll highway, based on a positioning result 38 outputted from the GNSS chip 7 and the determination result 39 outputted from the spoofing detecting section 31.

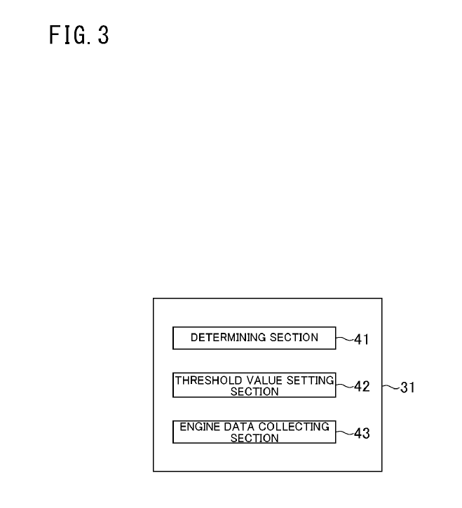

FIG. 3 shows functional blocks of the spoofing detecting section 31. The spoofing detecting section 31 has a determining section 41, a threshold value setting section 42 and an engine data collecting section 43. In the present embodiment, the determining section 41 is used. These functional blocks may be realized by a main CPU reading of the on-board unit 2 which reads a program stored in a storage unit, and which operates according to a procedure written in the program.

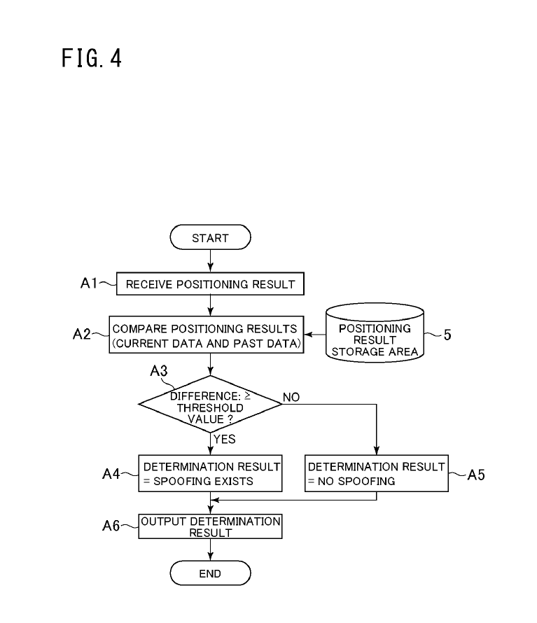

Next, an operation of the spoofing detecting section 31 of the present embodiment will be described with reference to FIG. 4. First, when the engine of the vehicle 1 is started up so that the on-board unit 2 is turned on, the GNSS chip 7 outputs the positioning results 35, 36, and 38 which are data showing a three-dimensional position of the vehicle 1 on the ground, based on the GNSS satellite information. The positioning result storing section 32 stores the positioning result 35 in the positioning result storage area 5 together with the positioning time showing a current time (Step A1).

The determining section 41 compares the current positioning result 36 outputted from the GNSS chip 7 and the past positioning result stored in the positioning result storage area 5. This comparison is executed by, for example, presetting a time difference quantity, reading a past positioning result based on the preset time difference quantity (e.g. 10 seconds before) from the positioning result storage area 5, and comparing the read past positioning result with the current positioning result 36 (Step A2).

The determining section 41 compares a difference between the past positioning result and the current positioning result and and a threshold value and determines which of them is more. As the threshold value at this time, a distance is set which seems to be unnatural for the vehicle 1 to move more during the preset time difference quantity used at step A2. For example, when the preset time difference quantity is set to 10 seconds and the threshold value is set to 500 meters, the movement is determined to be unnatural when the movement between the positioning result before 10 seconds and the current positioning result is equal to or more than 500 meters.

When the difference is not equal to or more than the threshold value (Step A3; NO), the determining section 41 determines that any spoofing has not been carried out and the positioning has been normally carried out (Step A5). When the difference is equal to or more than the threshold value (Step A3; YES), the determining section 41 determines that the spoofing has been carried out (Step A4).

The determining section 41 outputs a determination result 39 of the existence or non-existence of spoofing (Step A6). The main processing section 34 carries out processing such as charging processing based on the positioning result 38, taking the determination result 39 into consideration. For example, when the spoofing is determined to have been carried out, usual charging processing is stopped and the data showing the determination result 39 is stored in the storage unit.

Through the above processing, when the positioning result depending on the GNSS satellite information shows an unnatural leap as a result of the spoofing, the charging processing depending on spoofed data can be avoided.

In addition to the above spoofing detection processing, means for detecting a multipath may be provided which causes a positioning error in the satellite positioning system. In case of the positioning error due to the multipath, for example, a running route of the vehicle determined based on the satellite positioning shows a temporal unnatural leap and returns to an original correct positioning result again. Therefore, when a period for which the distance difference determined at step A3 is equal to or more than the threshold value is shorter than a given period, it may be determined that there is a possibility of the positioning error due to the multipath so as not to determine the spoofing.

The spoofing detection by the above described means has an advantage that the loading on the on-board unit 2 is easy. Below, the advantage will be described.

In the satellite positioning system, an exclusive-use GNSS chip is loaded on the on-board unit. In order to implement the spoofing detecting function, it could be considered to add a function of verifying the data received from the GNSS satellite to the GNSS chip. However, from the viewpoint of easiness of implementing, a technique is demanded that makes it possible to carry out the spoofing detection by using a signal outputted from the GNSS chip without applying any change to the GNSS chip.

A standard of signals outputted from the GNSS chip is set by NMEA (National Marine Electronics Association), and so on. If the spoofing can be detected based on the output signal defined in such a standard, what type of chip can be adopted, so that the degrees of freedom of the chip selection is high.

In the spoofing detection processing shown in FIG. 4, the estimated position of the vehicle 1 outputted from the GNSS chip 7 is used as the data generated by the satellite positioning system. It is determined in the standard that such an estimated position is outputted from the GNSS chip 7 of any type. The detailed information which the GNSS chip 7 does not always output, such as the orbit information and so on of the GNSS satellite is not needed for the spoofing detection in FIG. 4. Therefore, there are advantages that the spoofing detection processing shown in FIG. 4 can be executed without applying any change to the GNSS chip 7, and moreover, any type of the GNSS chip 7 can execute the processing. The other embodiments of the present invention to be described below have such advantages in the same way.

### Second Embodiment

Next, a second embodiment of the present invention will be described. Although the second embodiment has the same configuration as in the first embodiment shown in FIG. 1 and FIG. 2, the spoofing determining processing is carried out by the operation of a threshold value setting section 42 in addition to the determining section 41 of FIG. 3.

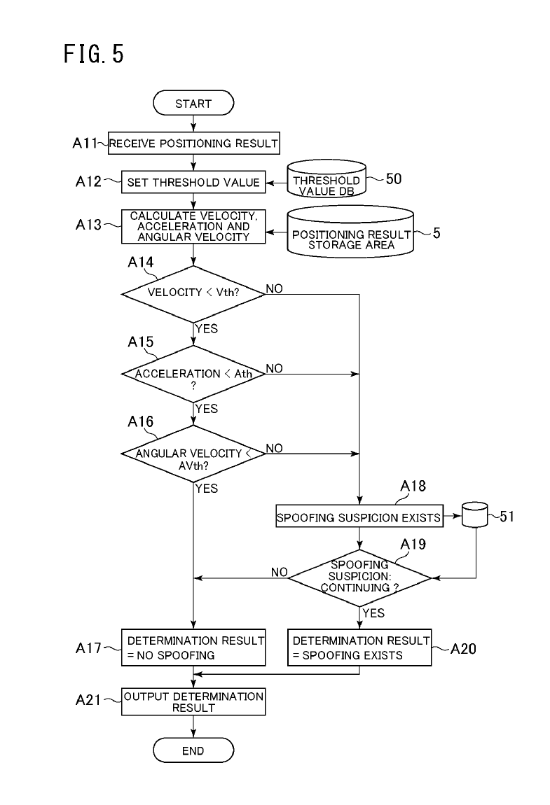

FIG. 5 is a flow chart showing the operation of the spoofing detecting section 31 according to the second embodiment of the present invention. The GNSS chip 7 outputs the positioning results 35, 36, and 38, like step A1 of FIG. 4. The positioning result storing section 32 stores the positioning result 35 in the positioning result storage area 5 together with the positioning time showing the current time (Step A11).

Next, the threshold value setting section 42 refers to a threshold value database 50 stored in the storage unit of the on-board unit 2 to set threshold values. For example, the position change of the vehicle 1 is fast while running on a highway, and is late while running on a built-up area. Therefore, it is possible to determine whether a time-series change of each of the positioning results 35, 36, and 38 of the vehicle 1 is unnatural, by setting the different threshold values of the running speed according to the current position of the vehicle 1.

To carry out such a determination, an area on a map and a threshold value are related to each other and stored in the threshold value database 50. For example, a large threshold value of speed is set to an area showing the highway and a small threshold value of speed is set to the area showing the built-up area. The threshold value setting section 42 extracts the threshold value corresponding to the current position of the vehicle 1 shown by the positioning result 36 outputted from the GNSS chip 7 from the threshold value database 50 and sets as the threshold value for the spoofing detection. For example, such a threshold value can be set to each of speed, acceleration, angular speed and so on of the vehicle (Step A12).

The determining section 41 calculates the current speed, the current acceleration and the current angular speed of the vehicle 1 based on the positioning result 36 outputted from the GNSS chip 7 and a record of past positioning result and positioning time stored in the positioning result storage area 5 (Step A13).

The determining section 41 compares the calculated speed of the vehicle 1 and the threshold value Vth of the speed set by the threshold value setting section 42 and determines which of them is more. When the speed of the vehicle 1 is smaller than the threshold value (step A14; YES), the control advances to the processing of step A15. When the speed of the vehicle 1 is equal to or more than the threshold value (step A14; NO), the determining section 41 determines that there is a suspicion that a spoofing has been carried out (Step A18).

The determining section 41 compares the calculated acceleration of the vehicle 1 and the threshold value Ath of acceleration set by the threshold value setting section 42 and determines which of them is more. When the acceleration of the vehicle 1 is smaller than the threshold value (step A15; YES), the control advances to the processing of step A16. When the acceleration of the vehicle 1 is equal to or more than the threshold value (step A15; NO), the determining section 41 determines that there is a suspicion that a spoofing has been carried out about (Step A18).

The determining section 41 compares the calculated angular speed of the vehicle 1 and the threshold value Ath of the angular speed set by the threshold value setting section 42 and determines which of them is more. When the angular speed of the vehicle 1 is smaller than the threshold value (step A16; YES), the control advances to the processing of step A17. When the angular speed of the vehicle 1 is equal to or more than the threshold value (step A16; NO), the determining section 41 determines that there is a suspicion that a spoofing has been carried out (Step A18). Through this processing, it is possible to determine that there is the spoofing suspicion when a change rate to the direction of the vehicle is unnaturally large.

The order of steps A14 to A16 may be optionally changed, and one or two kinds of processing of three kinds of processing may be executed. When a vehicle movement quantity showing the movement of the vehicle (speed, acceleration, and angular speed) falls below the threshold value in each kind of processing, the spoofing is determined not to have been carried out (Step A17).

In the present embodiment, the spoofing detecting section 31 may carry out the spoofing detection operation based on the comparison of the past positioning result and the current positioning result in the first embodiment shown in FIG. 4, in addition to the operation shown in FIG. 5. In such a case, only when it is determined in the operation of step A3 that there is no spoofing, the spoofing is determined not to have been carried out, in addition to processing of steps A14 to A16.

When it is determined that a spoofing suspicion exists, a record of spoofing suspicion is registered on the spoofing candidacy database 51 in relation to the current time outputted from the GNSS chip 7 at step A18.

When the spoofing suspicion has occurred, the determining section 41 extracts a record of past spoofing suspicion from the spoofing candidacy database 51. When a period for which the spoofing suspicion continues is shorter than a given threshold value (Step A19; NO), it is determined that it is a short-range positioning error due to a multipath and so on and any spoofing has not been carried out (Step A17). When the period for which the spoofing suspicion continues is equal to or longer than the given threshold value (Step A19; YES), a spoofing is determined to have been carried out (Step A20).

The determining section 41 outputs the determination result 39 showing the non-existence of spoofing determined at step A17 or the existence of spoofing determined at step A20 (Step A21). The main processing section 34 takes the determination result 39 into consideration when executing charging processing and so on based on the positioning result 38 outputted from the GNSS chip 7, like the first embodiment.

### (Spoofing Determination Using Start-Up State of Engine)

In addition to the above processing, a spoofing determination by the operation of an engine data collecting section 43 of FIG. 3 may be added. Generally, when the engine of the vehicle 1 is in a stop state, the position of the vehicle 1 does not change. When the position of the vehicle 1 estimated by the satellite positioning system changes over an extent while the engine of the vehicle 1 is in a stop state, it could be considered that there is a spoofing suspicion.

To detect such a spoofing suspicion, the engine data collecting section 43 shown in FIG. 3 monitors the ignition ON/OFF signal 19. When the engine of the vehicle 1 is determined to have been stopped based on the ignition ON/OFF signal 19 (an ignition key was is set to an off state), the engine data collecting section 43 stores the last positioning result 36 outputted from the GNSS chip 7 in the storage unit of the on-board unit 2 as the positioning result when the engine stops.

When the engine data collecting section 43 recognizes that the ignition ON/OFF signal 19 is changed from the OFF state to the ON state, the first positioning result 36 outputted from the GNSS chip 7 is transferred to the determining section 41 as the positioning result on the engine start-up together with the positioning result on the engine stop. The determining section 41 calculates a difference between the positioning result on the engine start-up and the positioning result on the engine stop. When the difference is smaller than a given threshold value, the determining section 41 determines to be normal. When being equal to or more than the given threshold value, the spoofing is determined to have been carried out.

### Third Embodiment

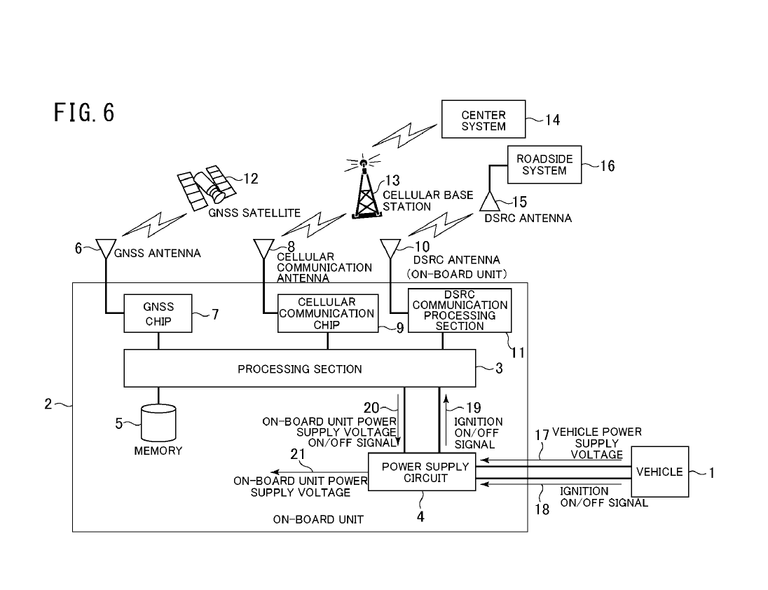

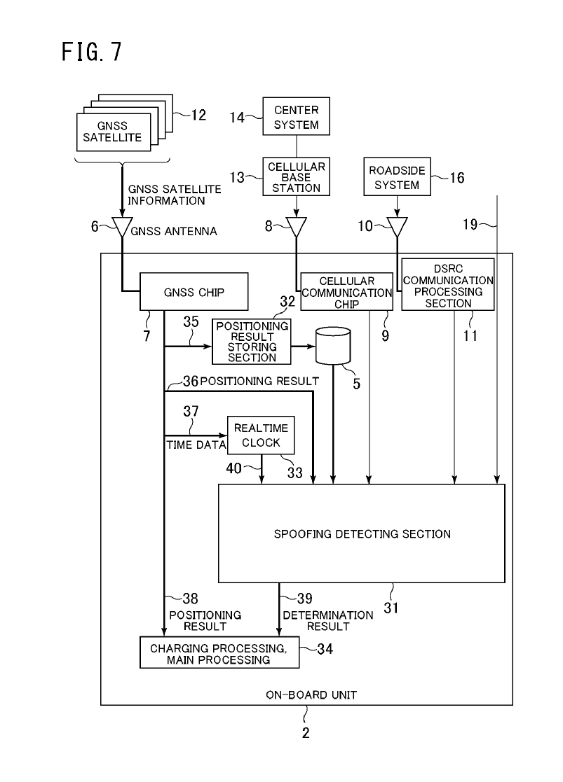

Next, a third embodiment of the present invention will be described. FIG. 6 shows a configuration of the satellite positioning system according to the third embodiment. FIG. 7 shows a configuration of the on-board unit 2 of the present embodiment. In the present embodiment, the following processing is carried out:

(1) the spoofing detection based on the past and current GNSS positioning results;

(2) the spoofing detection based on a comparison between GNSS time data and DSRC time data or a comparison between a GNSS time data and a cellular communication time; and

(3) the spoofing detection based on a comparison of the GNSS positioning result and a position of a DSRC roadside unit, or a comparison of the GNSS positioning result and a communication area of the cellular base station.

Of them, as for the processing (1), the processing described in the first embodiment or the second embodiment is carried out. In the present embodiment, the processing of (2) and (3) is further added. In the present embodiment, a cellular communication network and a roadside system are used for the processing.

The cellular communication is a technique used generally as one of the techniques of the mobile communication. The outline will be described below. In the cellular communication, a communication area is divided into many small cells and a base station is installed in each cell. The area of the cell is typically in a range of about several kilometers of ten and several kilometers, centered on the base station, but a technique may be used in which the communication area is divided into micro cells which are smaller than the cells. The output of radio wave of each base station is an extent to cover the cell which the base station belongs, as a communication area. That is, each base station is installed apart from another base station not to cause radio wave interference with the other base station. Therefore, the same frequency can be used in the different base stations so that it is possible to use the frequency band effectively.

The cellular communication network has a center system 14 and a plurality of cellular base stations 13. The on-board unit 2 has a cellular communication antenna 8 and a cellular communication chip 9. The cellular communication network can be used as a part of a toll highway charging system using a position estimation result of the vehicle 1 by the GNSS. The GNSS chip 7 estimates and outputs the position of the vehicle 1 as a positioning result based on the GNSS satellite information received from the GNSS satellite 12. The cellular communication chip 9 transmits the positioning result from the cellular communication antenna 8. The positioning result is transmitted to the center system 14 through the cellular base station 13 near the vehicle 1. Because the on-board unit 2 and the cellular communication network communicate bidirectionally, the processing such as the charging processing by using the positioning result of the vehicle 1 is carried out.

The roadside system 16 is connected with a plurality of DSRC antennas 15 which are installed on the side of the road such as the road on which the vehicle runs and the parking lot. The on-board unit 2 has a DSRC antenna 10 for carrying out a bidirectional narrow area exclusive-use communication (DSRC: Dedicated Short Range Communication) with the DSRC antennas 15 and the DSRC communication processing section 11.

### (Time Data Acquired by DSRC)

As shown in FIG. 7, the on-board unit 2 in the present embodiment has a realtime clock 33. The GNSS time data 37 showing the current time is contained in data generated by the GNSS chip 7 based on the GNSS satellite information. The GNSS chip 7 outputs the GNSS time data 37 to the realtime clock 33 in the on-board unit 2. The realtime clock 33 outputs the GNSS time data 40 in the form which can be used as a time stamp and so on in the processing by the on-board unit 2. The GNSS time data 37 outputted from the GNSS chip 7 and the GNSS time data 40 outputted from the realtime clock 33 are different in the form but have substantively the same contents.

The roadside system 16 always generates the DSRC time data showing the current time. The DSRC communication processing section 11 receives the DSRC time data through the DSRC antenna 10 and transfers it to the spoofing detecting section 31.

### (Position Data Acquired by DSRC)

The roadside system 16 transmits the DSRC position data showing the position of the DSRC antenna (a roadside unit). The DSRC communication processing section 11 transfers the DSRC position data received by the DSRC antenna 10 to the spoofing detecting section 31 as the DSRC positioning result.

### (Configuration of Spoofing Detecting Section)

The positioning result 36 outputted from the GNSS chip 7 and the GNSS time data 40 outputted from the realtime clock 33 are supplied to the spoofing detecting section 31. The spoofing detecting section 31 outputs the determination result 39 showing whether or not a spoofing has been carried out, based on the positioning result 36, the GNSS time data 40 and the DSRC time data.

The spoofing detecting section 31 further outputs the determination result 39 showing whether a spoofing has been carried out, based on the positioning result 36 outputted from the GNSS chip 7 (the GNSS positioning result) and the DSRC positioning result. The main processing section 34 executes the charging processing when the vehicle 1 runs the toll highway and so on, based on the positioning result 38 outputted from the GNSS chip 7 and the determination result 39 outputted from the spoofing detecting section 31.

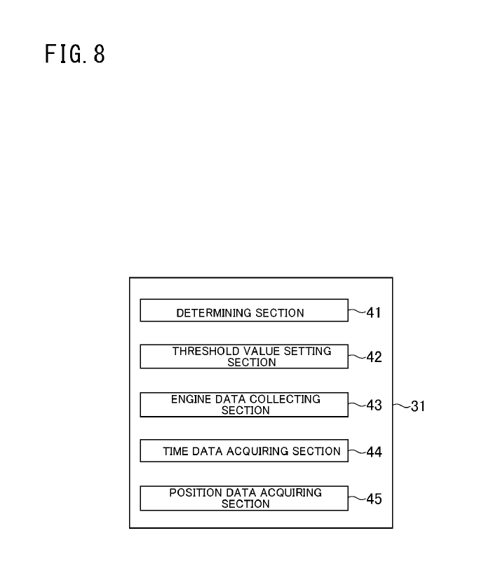

FIG. 8 shows functional blocks of the spoofing detecting section 31. The spoofing detecting section 31 in the present embodiment has a time data acquiring section 44 and a position data acquiring section 45 in addition to the functional blocks of the first embodiment shown in FIG. 3. These functional blocks can be realized by a main CPU of the on-board unit 2 reading a program stored in the storage unit, and operating according to a procedure defined in the program.

### (Operation of Spoofing Detecting Section Using DSRC Time Data)

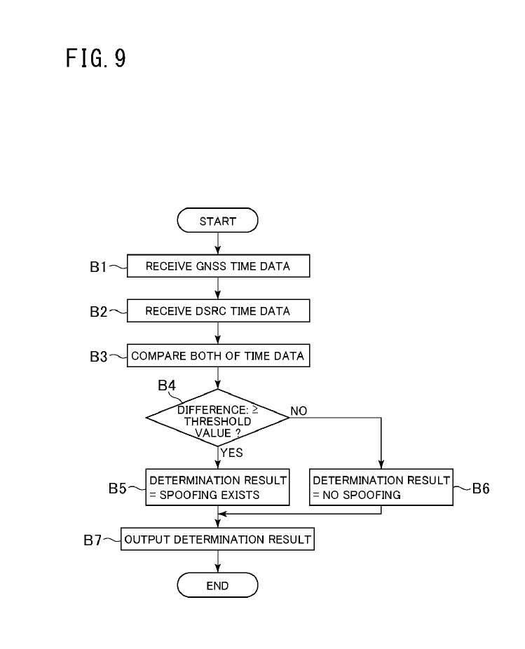

Next, an operation of the spoofing detecting section 31 of the present embodiment will be described. In the present embodiment, the spoofing detecting section 31 carries out the spoofing detection (the previously mentioned processing (2)) based on the comparison between the GNSS time data and the DSRC time data. FIG. 9 is a flow chart showing the spoofing detection based on the comparison between the GNSS time data and the DSRC time data in the present embodiment.

First, when the engine of the vehicle 1 is started up to turn on the on-board unit 2, the GNSS chip 7 outputs the GNSS time data 37 showing the current time, based on the GNSS satellite information. The realtime clock 33 outputs the GNSS time data 40 corresponding to the GNSS time data 37 to the spoofing detecting section 31 in approximately realtime (Step B1). The time data acquiring section 44 acquires the DSRC time data from the DSRC communication processing section 11 in approximately realtime (Step B2).

The determining section 41 compares the GNSS time data 40 and the DSRC time data (Step B3). When a difference between the GNSS time data 40 and the DSRC time data is smaller than a given threshold value (Step B4; NO), the determining section 41 determines that the spoofing has not been carried out (Step B6). When the difference between the GNSS time data 40 and the DSRC time data is equal to or more than the threshold value (Step B4; YES), the determining section 41 determines that the spoofing has been carried out (Step B5).

The determining section 41 outputs the determination result 39 showing the existence or non-existence of spoofing (Step B7). The main processing section 34 takes the determination result 39 into consideration and carries out processing, in case of carrying out the processing such as the charging processing based on the positioning result 38. For example, when the spoofing is determined to have been carried out, the main processing section 34 stops usual charging processing and stores the data showing the determination result 39 in the storage unit.

As one of the techniques of the spoofing, it could be spoofed as if the data of the past positioning result by the satellite positioning system is used as the current position data of the vehicle. In such a case, there is a possibility that the time data contained in the data for the spoofing is different from the current time data. In such a case, in the processing of the present embodiment, the spoofing can be detected by comparing and verifying a time by the satellite positioning system and the time provided from the roadside system 16.

### (Spoofing Detection Using Cellular Communication Network Time Data)

As a modification example of the spoofing detection shown in FIG. 9, the cellular communication may be used in place of the roadside system 16. In the modification example, the cellular communication network generates the cellular communication time data showing the current time. The cellular communication time data is transmitted to the on-board unit 2 from the cellular base station 13. The cellular communication chip 9 transfers the cellular communication time data received through the cellular communication antenna 8 to the spoofing detecting section 31 in approximately realtime.

In the modification example, the spoofing detecting section 31 receives the cellular communication time data in place of the DSRC time data at the step B2 of FIG. 9. The other kinds of processing are the same as those of FIG. 9. In such a satellite positioning system, the spoofing can be detected by verifying the reliability of the GNSS time data by using the time supplied from the cellular communication network, even in an area where the DSRC roadside unit is not installed.

### (Operation of Spoofing Detecting Section Using DSRC Position Data)

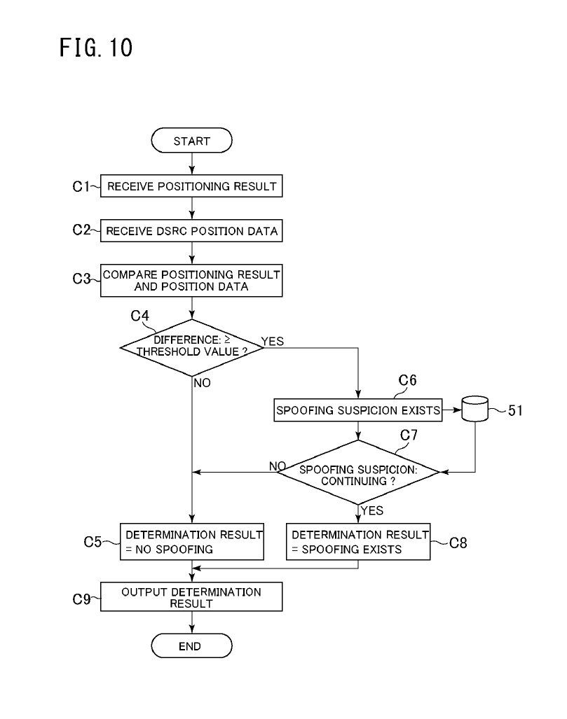

In the present embodiment, the spoofing detecting section 31 further carries out the spoofing detection (the processing (3)) based on the comparison of the position of the GNSS positioning result and the position of the DSRC roadside unit. FIG. 10 is a flow chart showing the operation of the spoofing detecting section 31 in case of the spoofing detection based on the comparison of the position of the GNSS positioning result and the position of the DSRC roadside unit in the present embodiment.

First, when the engine of the vehicle 1 is started up to turn on the on-board unit 2, the GNSS chip 7 outputs the positioning results 36 and 38 which are the data showing a three-dimensional position of the vehicle 1 on the ground based on the GNSS satellite information (Step C1). The position data acquiring section 45 receives the DSRC positioning result from DSRC communication processing section 11 in approximately realtime (Step C2).

The determining section 41 compares the current positioning result 36 outputted from the GNSS chip 7 (the GNSS positioning result) and the DSRC positioning result (Step C3). The determining section 41 compares a difference between (the distance between both of) the position shown by the GNSS positioning result and the position shown by the DSRC positioning result and a preset threshold value, and determines which of them is more. As the threshold value, a distance which is equal to or more than a communication area of the DSRC roadside unit is set. The determining section 41 advances to the processing of step C5 when the difference is smaller than the threshold value (step C4; NO), and advances to the processing of step C6 when the difference is equal to or more than the threshold value (step C4; YES).

When the determination of “YES” is made at step C4, the determining section 41 determines that there is a spoofing suspicion (Step C6). When the spoofing suspicion is determined to exist, a record of spoofing suspicion is registered on the spoofing candidacy database 51 in relation to the current time.

When the spoofing suspicion has occurred, the determining section 41 extracts the record of past spoofing suspicion from the spoofing candidacy database 51. When a period for which the spoofing suspicion continues is shorter than a given threshold value (Step C7; NO), it is a short-range positioning error due to the multipath and so on and any spoofing is determined not to have been carried out (Step C5). When the period for which the spoofing suspicion continues is equal to or longer than the threshold value (Step C7; YES), the spoofing is determined to have been carried out (Step C8).

The determining section 41 outputs the determination result showing the non-existence of spoofing generated at step C5 or the existence of spoofing generated generated at step C8 (Step C9). The main processing section 34 takes the determination result 39 into consideration when executing the charging processing and so on based on the positioning result 38 outputted from the GNSS chip 7. For example, when the spoofing is determined to have been carried out, the main processing section 34 stops usual charging processing and stores the data showing the determination result 39 in the storage unit.

The spoofing can be detected by the above processing, when the positioning result based on the GNSS satellite information is apart unnaturally from the position of the communicating DSRC roadside unit as a result of the spoofing.

### (Operation of Spoofing Detecting Section Using Cellular Base Station Position Data)

The spoofing can be detected based on the position (the communication area) of the cellular base station 13, in place of the DSRC position data shown in FIG. 10. The cellular communication network transmits an identifier for specifying the cellular base station 13 communicating with the on-board unit 2 to the on-board unit 2, in case of carrying out communication for the charging processing and so on with the on-board unit 2 through cellular base station 13. By the identifier, a rough position of the vehicle 1 can be recognized and it is possible to use instead of the DSRC positioning result in the first embodiment.

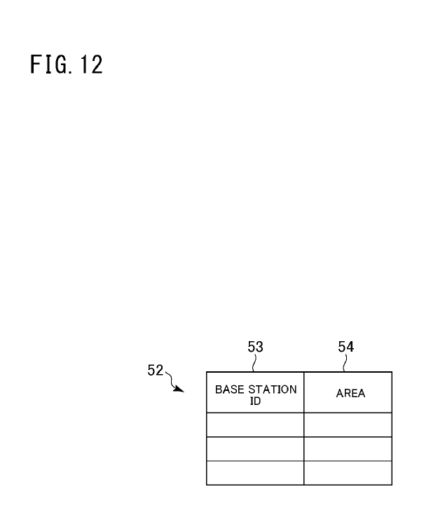

FIG. 12 shows a base station ID table 52 which is previously registered on the spoofing detecting section 31 in the present embodiment. The base station ID table 52 relates the base station ID 53 which is an identifier for specifying each of the plurality of base stations and an area 54 which is the data showing the communication area covered by each cellular base station 13.

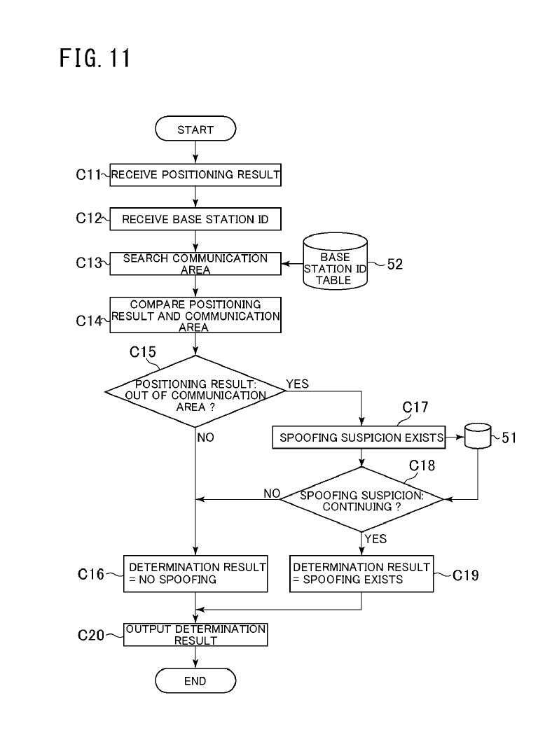

FIG. 11 shows an operation of the spoofing detecting section 31 in the present embodiment. Like the step C1 of FIG. 10, the positioning result 36 by the satellite positioning system is supplied to the spoofing detecting section 31 (Step C11). The cellular communication chip 9 extracts the base station ID 53 for specifying the communicating cellular base station 13 from among signals received from the cellular base station 13 through the cellular communication antenna 8. The position data acquiring section 45 receives the base station ID 53 from the cellular communication chip 9 (Step C12). The position data acquiring section 45 searches the area 54 corresponding to the base station ID 53 acquired from the cellular communication chip 9 from the base station ID table 52 (Step C13).

The determining section 41 compares the position shown by the GNSS positioning result and the area 54 (the cellular base station communication area) searched from the base station ID table 52 (Step C14). The determining section 41 advances to the processing of step C16 when the GNSS positioning result is in a cellular base station communication area (step C15; NO), and advances to the processing of step C17 when being not in the area (step C15; YES). The processing of steps C16 to C20 is the same as the processing of steps C5 to C9 of FIG. 10.

In the present embodiment, the spoofing detecting section 31 detects a spoofing by using the position of the communicating cellular base station 13 in place of the DSRC positioning result in case of operation shown in FIG. 10. In such a satellite positioning system, the spoofing can be detected even in the area where the DSRC roadside unit is not installed.

By carrying out the processing shown in FIG. 9 and the processing shown in FIG. 10 in addition to the processing of the spoofing detecting section 31 shown in FIG. 4 or FIG. 5, the following three spoofing detection results are obtained:

(1) the spoofing detection based on the past and current GNSS positioning results;

(2) the spoofing detection based on a comparison of the GNSS time data and the DSRC time data (or the cellular communication time data); and

(3) the spoofing detection based on the comparison of the GNSS positioning result and the position of the DSRC roadside unit (or a communication area of the cellular base station).

When determined to be “the existence of spoofing” in at least one of the above three spoofing detecting methods, the spoofing detecting section 31 outputs the determination result 39 that there is a spoofing as a whole. Or, when determined to be “the existence of spoofing” in at least two of the above three spoofing detecting methods, the spoofing detecting section 31 may adopt a majority vote method in which the determination result 39 of “the existence of spoofing” as a whole is outputted. Or, in addition to the same processing method (1) as the first embodiment, one of the processing method (2) and the processing method (3) may be adopted. In this case, when the spoofing is detected in at least one of the two processing methods, the determination result 39 of the existence of spoofing as a whole is outputted. Or, when the spoofing is detected in both of the two processing methods, the determination result 39 of the existence of spoofing as a whole may be outputted.

1. An on-board unit comprising:
a positioning section configured to output a positioning result showing a current position of a vehicle based on a positioning signal received from an artificial satellite;
a positioning result storage section configured to store the positioning result in relation to a time; and
a processing section configured to detect a spoofing based on whether a movement of the vehicle satisfies a given condition, by using a past positioning result stored in the positioning result storage section and a current positioning result measured by the positioning section.

2. The on-board unit according to claim 1, wherein the given condition is a condition to determine that a spoofing has been carried out, when a speed of the vehicle is equal to or faster than a given threshold value.

3. The on-board unit according to claim 2, wherein the processing section sets the given threshold value according to an area on a map where the vehicle exists.

4. The on-board unit according to claim 1, wherein the processing section determines that the spoofing has been carried out, when an acceleration of the vehicle is equal to or more than a given threshold value.

5. The on-board unit according to claim 1, wherein the processing section determines that the spoofing has been carried out, when an angular speed of the vehicle is equal to or more than a given threshold value.

6. The on-board unit according to claim 1, wherein the processing section is configured to collect start-up information showing whether an engine of the vehicle has started up, and determines that the spoofing has been carried out, when the start-up information shows that the engine has not been started up and the positioning result shows that the vehicle is moving.

7. The on-board unit according to claim 1, wherein the processing section determines that there is a spoofing suspicion, when the movement of the vehicle does not satisfy a given reference, and determines that the spoofing has been carried out when the spoofing suspicion continues for a given period or more.

8. A spoofing detecting method of an on-board unit, comprising:
outputting a positioning result showing a current position of a vehicle based on a positioning signal received from an artificial satellite;
storing the positioning result in a storage device in relation to a time; and
detecting a spoofing based on whether a movement of the vehicle satisfies a given condition, by using a past positioning result stored in the positioning result storage section and a current positioning result measured by the positioning section.
